(19) United States
(12) Patent Application Publication
(10) Pub. No.: US 2019/0315230 A1
(43) Pub. Date: Oct. 17, 2019

(54) OPERATING DEVICE FOR AN INFOTAINMENT SYSTEM OF A MOTOR VEHICLE, AND A METHOD FOR DETERMINING THE LOCATION OF AN OPERATOR OF SUCH AN OPERATING ELEMENT

(71) Applicant: ZF FRIEDRICHSHAFEN AG, Friedrichshafen (DE)

(72) Inventors: Werner RIEGEL, Markdorf (DE); Mirko MORGENTHUM-NEURODE, Würselen (DE)

(73) Assignee: ZF FRIEDRICHSHAFEN AG, Friedrichshafen (DE)

(21) Appl. No.: 16/466,598

(22) PCT Filed: Nov. 8, 2017
(86) PCT No.: PCT/EP2017/078562

§ 371 Date: Jun. 4, 2019

(30) Foreign Application Priority Data
Dec. 9, 2016 (DE) 10 2016 224 635.6

(51) Int. Cl. B60K 37/06

(52) U.S. Cl. CPC B60K 37/06; B60K 2370/126; B60K 2370/141; B60K 2370/197; B60K 2370/741; B60K 2370/774; B60K 2370/48; B60K 2370/143

(57) ABSTRACT

The invention relates to an operating device for an infotainment system of a motor vehicle that has an operating element (3a) for operating the infotainment system (2), a sensor device (6) for determining at least one finger position (10, 11, 12) of an operator on the operating element (3a), and an evaluation device (7) for determining the location of the operator based on the at least one finger position (10, 11, 12) determined by the sensor device (6), wherein the evaluation device (7) is configured to activate a predetermined function of the infotainment system (2) when the location of the operator meets a predetermined criterion. The invention also relates to a method for determining the location of the operator of an operating element for an infotainment system.

The present invention relates to an operating device for an infotainment system of a motor vehicle, a method for determining the position of a user of such an operating element, and a motor vehicle.

Known infotainment systems are now equipped with numerous functions and sub-functions that can be accessed via menus, which distract a driver when driving, and disrupt his attention to driving events. Either the driver does not need many of these functions while driving, or they can only be accessed via confusing menus and thus distract the driver unnecessarily.

A person-specific operating interface is known from EP 1 961 618, wherein specific functions are selectively activated in a vehicle for the driver or the passenger in the front seat. The same operation of an operating element, e.g. pushing a button, can thus be used to activate a specific function when this action is taken by the driver, and another function when the action is taken by the passenger in the front seat. A dual-view touchscreen display can also be operated with the system from a passenger's perspective as well as a driver's perspective. With the systems known from the prior art, a high frequency electric signal is conducted into the body of the driver and the passenger in order to distinguish between the driver and passenger via electrically conductive plates in the front vehicle seats. If one of the two then touches a button on the operating interface, the respective high frequency signal belonging to person can be detected in the button, and the person can thus be identified. The disadvantage with this system is that the operator must be permanently seated in his vehicle seat in order to come in contact with the electrically conductive plate. Furthermore, each button must be equipped with electrical contacts, in order to pick up the high frequency signal from the operator.

Operating elements for operating infotainment systems in a motor vehicle, for example, are know from, e.g., DE 10 2011 108 214 A1 and DE 10 2007 035 564 A1.

A method for operating an operator interface in a motor vehicle is known fro DE 10 2013 000 083 A1, in which the location of the operator is determined by a camera assembly.

The object of the invention is to provide an improved operating device for an infotainment system in a motor vehicle. A further object is to provide a method with which the location of the operator of an operating element of an infotainment system can be determined.

These objects are achieved with an operating device and the method according to the features of the independent claims. Advantageous embodiments are the subject matter of the dependent claims.

The operating device according to the invention for an infotainment system of a motor vehicle has an operating element for operating the infotainment system, a sensor device for determining at least one operator finger position on the operating element, and an evaluation device for determining the location of the operator based on the at least one finger position of the operator determined by the sensor device. The evaluation device is configured to activate a predetermined function of the infotainment system when the location of the operator meets a predetermined criterion.

Furthermore, with respect to the sensor device, the term “determination of a finger position” is to be understood to mean that the presence of a finger on or in the immediate proximity of the operating element is detected by means of the sensor device. Moreover, the term “determination of a finger position” is also understood to mean that the exact position of the detected finger on or in the immediate proximity of the operating element is determined.

In one embodiment, the sensor device is configured to identify the fingerprint of the operator.

The operating element for an infotainment system, aside from the function buttons that are integrated in the steering wheel, is located in known vehicles in the central console of the vehicle, which is located between the driver and the passenger. As a result, with motor vehicles with left-hand steering, the driver operates the operating element for the infotainment system with the right hand, and the passenger operates it with the left hand. With vehicle with right-hand steering, this is reversed.

The operating element is ideally a control element that can rotate about an axis. In particular, the operating element can be in the from of a rotating push-button knob. The operating element can also have a touchpad on its surface. The user is able to operate the infotainment system via this touchpad through the movements of his finger thereon.

The sensor device for the operating device has an sensor surface in one embodiment, which runs along at least a segment of the circumference of the operating element. In particular, the sensor surface is annular, or in the form of an arc.

In one embodiment, the sensor surface is divided into at least two segments. In this case, a first segment of the sensor surface is dedicated to the driver of the motor vehicle, and a second segment of the sensor surface is dedicated to the passenger of the motor vehicle. There is at least a third segment located between the first and second segments, on the longitudinal axis of the vehicle, in another embodiment. Based on a clock face, in which 12 indicates the direction of travel, the first segment is located between 6 and 9, and the second segment is located between 3 and 6. The third segment is located between 9 and 3.

The operator fundamentally uses his thumb to operate the operating element, or the control element. When touching the operating element, the driver touches the operating element with his right thumb at a side of the operating element facing him (the driver), while the passenger touches the operating element at a side of the operating element facing him (the passenger). With the other fingers, in particular the index finger and the middle finger, the operator touches the operating element at points lying opposite (the thumb). As a result, the driver only touches the operating element with his thumb in the first segment of the sensor surface. The second segment of the sensor surface is never touched by the driver. In the same manner, the passenger only touches the second segment with his thumb.

There is comparison device for comparing fingerprints and a memory for storing fingerprints in one embodiment. The sensor device is thus configured to identify the fingerprint of the operator. The comparison device is configured to compare the fingerprint of the operator identified by the sensor device with a fingerprint of an authorized individual stored in the memory. In this manner, it can be ensured that the operating device for the infotainment system can only be controlled by an authorized individual. It is also possible that only certain functions of the infotainment system can be selected or displayed for the identified fingerprint.

Another aspect of the invention relates to a method for determining the location of an operator of an operating device for an infotainment system in a motor vehicle. The position of the operator's finger on the operating element is determined according to the invention by means of the sensor device, and the location of the operator is determined by means of an evaluation device, based on the determined finger position.

As explained above, the driver and passenger operate the operating element of an operating device for an infotainment system in a motor vehicle with the opposite hands. In a left-hand steering vehicle, the driver operates the operating element with the right hand, and the passenger operates it with the left hand. In a right-hand steering vehicle, the driver operates the operating element with the left hand, and the passenger with the right. The point where the finger of the driver touches the operating element thus differs from the point where the finger of the passenger touches the operating element. As a result, it is possible to determine whether the driver or the passenger is operating the operating element.

In one embodiment of the method according to the invention, the sensor device has a sensor surface that is divided into at least two segments. A first segment of the sensor surface is dedicated to a driver of the motor vehicle, and a second segment of the sensor surface is dedicated to a passenger of the motor vehicle. The driver is identified as the operator of the operating element when it has been determined that a finger is touching the first segment of the sensor surface, and the passenger is identified as the operator when it has been determined that a finger is touching the second segment of the sensor surface.

In another embodiment, the driver is identified as the operator when it has been determined that a finger is touching the first segment, and a third segment of the sensor surface, wherein the third segment is located between the first and second segments. The passenger is identified as the operator when it has been determined that a finger is touching the second segment and the third segment of the sensor surface.

The invention shall be explained in greater detail below based on the figures.

Therein:

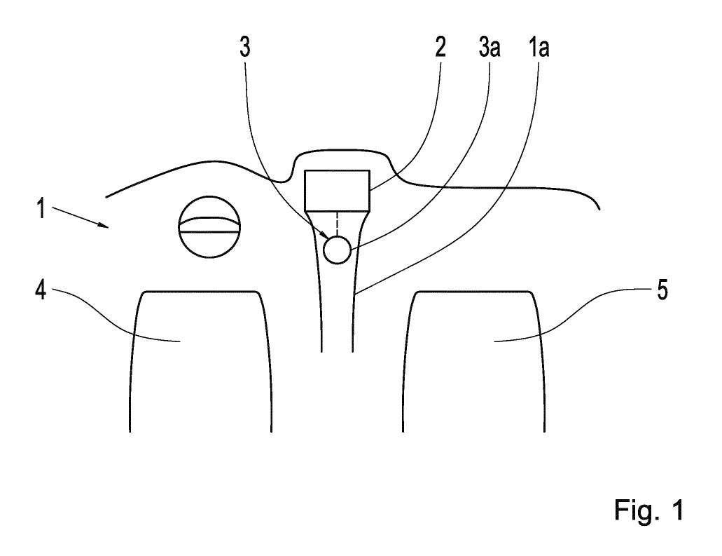

FIG. 1 shows a schematic illustration of the interior of a motor vehicle that has an infotainment system;

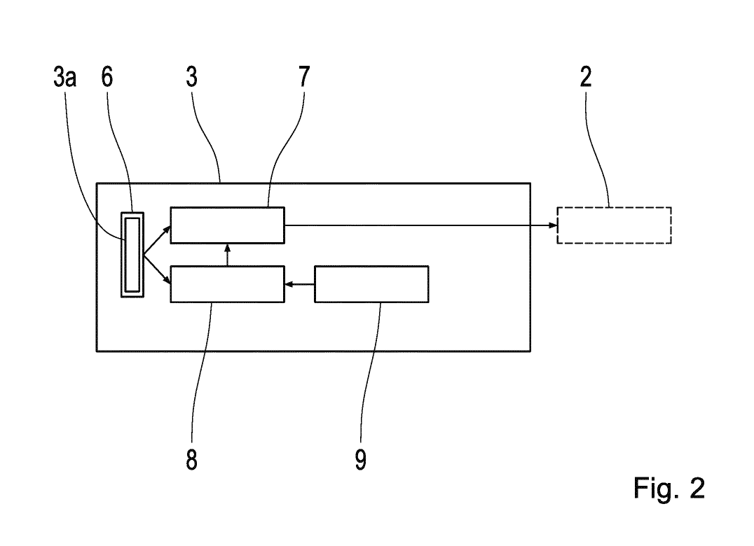

FIG. 2 shows a block diagram for an operating device that can be installed in an embodiment in a motor vehicle according the invention;

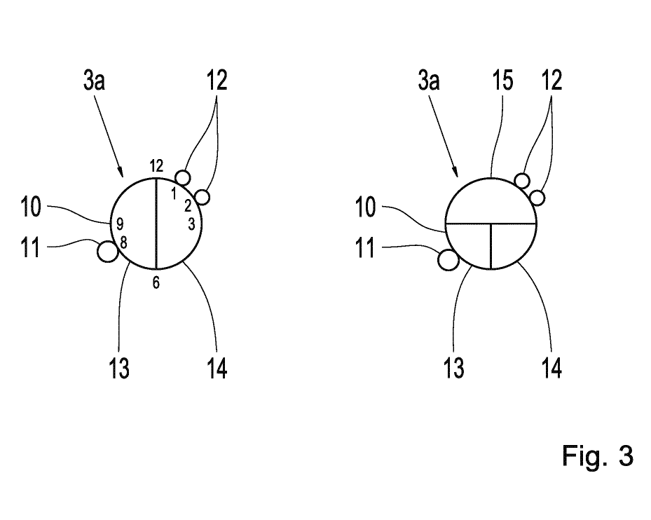

FIG. 3 shows a schematic illustration of an operating element of an operating device where the driver is the user;

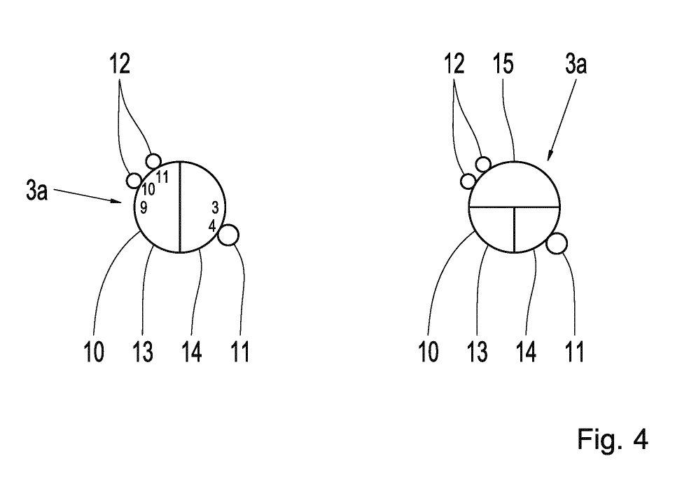

FIG. 4 shows a schematic illustration of an operating element of an operating device where the passenger is the user; and

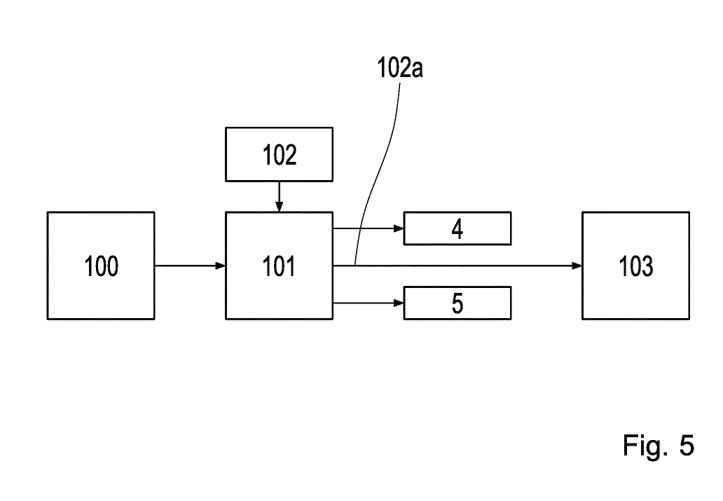

FIG. 5 shows the method steps for identifying the operator according to the invention.

FIG. 1 shows a schematic illustration of the interior 1 of a motor vehicle. With a left-hand steering vehicle, the seat for the driver 4 is on the left side of the interior 1, and the seat for the passenger 5 is on the right side. With a right-hand steering vehicle, this is reversed. It should be noted that the invention can be used in right-hand as well as left-hand steering vehicles. The central console la is located between the driver 4 and the passenger 5, in which the infotainment system 2 and an operating device 3 for operating the infotainment system are integrated. The operating device 3 is normally an operating device 3a that can be rotated axially, which can also be in the form of a rotating push-button knob. Various functions can be selected on the infotainment system 2 by means of this operating element 3a, e.g. the navigation system, radio, etc.

FIG. 2 shows a block diagram for an operating device according to the invention. The operating device 3 has an operating element 3a that has a sensor unit 6. The sensor unit 6 can be a capacitive sensor or a proximity sensor. Any sensor that can detect the presence of a finger is fundamentally suitable for this. The sensor unit 6 is configured to detect when one or more fingers of the operator (not shown) touch the operating element 3a. The sensor unit 6 is also configured to determine the position of the finger where the operating device is touched by the operator, or the position or positions on the operating device where the finger of the operator is in the immediate proximity. The sensor unit 6 is connected to an evaluation unit 7. The evaluation unit 7 determines whether the operator is the driver or the passenger based on the finger positions determined by the sensor unit 6. The evaluation unit 7 transmits corresponding information to the infotainment system, which activates or deactivates predetermined functions, depending on the location of the operator. As a result, it is possible, for example, for certain functions of the infotainment system to only be available to the passenger while the vehicle is being driven.

The operating device 3 also has a comparison device 8, which is connected to the sensor unit 6. This comparison device 8 is configured to compare a fingerprint detected by the sensor unit 6 with a fingerprint of an authorized operator stored in a memory 9. The resulting information is sent to the evaluation unit 7. The evaluation unit 7 transmits corresponding information to the infotainment system, which activates and deactivates specific functions, depending on the location of the operator, and whether he is authorized. As a result, certain functions of the infotainment system, e.g. contact lists stored in the infotainment system, cannot be activated by an unauthorized operator.

FIG. 3 and FIG. 4 show schematic illustrations of an operating element 3a of an operating device when used by an operator in a left-hand steering vehicle. The operating element 3a has a sensor surface 10, which is located at least in part along the circumference of the operating element 3a. The left-hand illustrations in FIG. 3 and FIG. 4 show an operating element 3a in which the sensor surface 10 is divided into two segments 13, 14. The separating line between the two segments 13, 14 runs along the vehicle axis, by way of example. The sensor surface 10 runs in relation to the illustration on a clock face (where 12 and 6 lie on the vehicle axis, and 12 is in the direction of travel, left-hand illustrations in FIGS. 3, 4) between 3 and 6 (second segment 14) and between 6 and 9 (first segment 13).

The right-hand illustrations in FIG. 3 and FIG. 4 show an operating element 3a, in which the sensor surface 10 is divided into three segments 13, 14, 15, and runs substantially along the entire circumference of the operating element 3a. The separating line between the first segment 13 and the second segment 14 runs along the vehicle axis, by way of example, and the separating line between the third segment 15 and the first and second segments 13, 14 is perpendicular to the vehicle axis, by way of example. The courses of the respective separating lines can of course be different, as long as, when viewed on a clock face (where 12 and 6 are on the vehicle axis, left-hand illustration in FIG. 3), the first segment 11 lies at least in the region between 7 and 8, the second segment 12 lies at least in the region between 4 and 5, and the third segment 15 lies at least in the region between 10 and 2.

The operating element 3a is, e.g., a control element that can be rotated axially, which can also be in the form of a rotating push-button knob. An operator normally operates such a control element with two or three fingers, specifically the thumb and the index finger, or the thumb, and the index and middle finger. The reference numeral 11 indicates the thumb of the operator, and the reference numeral 12 indicates the index and middle fingers of the operator in FIG. 3 and FIG. 4. FIG. 3 and FIG. 4 illustrate the device when it is operated with three fingers.

Because of the anatomy of the right hand of the driver, the thumb 11 touches the operating element 3a in the region of the 8 on a clock face (FIG. 3). The index finger and the middle finger touch the control element in the region between the 1 and the 2 on the clock face. The ring finger and little finger are not normally used to actuate the control element 3a. Depending on the size of the hand, the control element may be touched in the region between the 4 and the 5 on the clock face. When the driver is the operator, the operating element 3a is touched in the segments 11 and 14 (left-hand illustration in FIG. 3), or in the segments 11 and 15 (right-hand illustration in FIG. 3).

The passenger touches the operating element 3a in the region of the 4 on the clock face, in the second segment 14, due to the anatomy of the left hand. The passenger touches the operating element 3a with the index finger and the middle finger 12 in the region between the 10 and 11 on the clock face, in the first segment 10 (left-hand illustration in FIG. 4), or in the third section 15 (right-hand illustration in FIG. 4).

It should be noted that, depending on the position of the operating element on the central console, the positions where the operator touches the operating element can vary slightly. The finger positions given above in relation to a clock face should therefore not be regarded as precise. They indicate a point of reference for the regions on a clock face where the operating element is touched.

FIG. 5 shows a flow chart for determining the location of the operator according to the invention. In a first step 100, the sensor unit detects and determines the positions where the fingers touch the operating element. The determined finger positions are transmitted to an evaluation device in which the operator is identified as either the driver or the passenger in a second step 101, based on the determined finger positions on the operating element. In another step 103, the location of the operator is transmitted to the infotainment system, which allows or blocks specific functions, depending on who the operator is.

In an optional step 102, a fingerprint of an authorized person stored in a memory can be transmitted to the evaluation unit. This fingerprint is compared with a fingerprint detected by the sensor unit in step 100. The results 102a of the comparison of the fingerprint detected by the sensor unit with a stored fingerprint are then transmitted with the information regarding the position of the operator to the infotainment system in a third step 103. The infotainment system then activates predetermined functions for the operator, or blocks predetermined functions, based on the transmitted information.

### REFERENCE SYMBOLS

1 Motor vehicle interior
101 console
2 infotainment system
3 operating device
3a operating element
4 driver
5 passenger
6 sensor device
7 evaluation device
8 comparison device
9 memory
10 sensor surface
11 finger 1
12 finger 2
13 first segment
14 second segment
15 third segment
100 first step: identifying the finger position
101 second step: evaluation of the position of the operator
102 step for inputting a stored fingerprint
102a transmitting comparison results of the detected fingerprint with the stored fingerprint
103 third step: transmitting the position of the operator to the infotainment system

1. An operating device for an infotainment system of a motor vehicle that has an operating element for operating the infotainment system, a sensor device for determining at least one finger position of an operator on the operating element, and an evaluation device for determining the location of the operator based on the at least one finger position of the operator determined by the sensor device, wherein the evaluation device is configured to activate a predetermined function of the infotainment system when the location of the operator meets a predetermined criterion.

2. The operating device according to claim 1, characterized in that the operating element is a control element that can rotate about an axis.

3. The operating device according to claim 1, characterized in that the sensor device has a sensor surface that is located at least in segments along the circumference of the operating element.

4. The operating device according to claim 1, characterized in that the sensor surface of the sensor device of the operating element is divided into at least two segments.

5. The operating device according to claim 4, characterized in that the first segment of the sensor surface is dedicated to a driver of the motor vehicle, and a second segment of the sensor surface is dedicated to a passenger of the motor vehicle.

6. The operating device according to claim 5, characterized in that at least on third segment is located between the first segment and the second segment on the longitudinal axis of the vehicle.

7. The operating device according to claim 1, characterized in that there is a comparison device for comparing fingerprints and a memory for storing fingerprints, wherein the sensor device is configured to identify the fingerprint of the operator, and the comparison device is configured to compare the identified fingerprint of the operator with a fingerprint of an authorized individual stored in the memory.

8. A method for determining the location of an operator of an operating element for an infotainment system in a motor vehicle by means of a sensor device, characterized in that the positions of the fingers of the operator on the operating element are determined in a first step by means of the sensor device, and the location of the operator is determined by means of an evaluation device in a second step based on the determined finger positions.

9. The method according to claim 8, characterized in that the sensor device has a sensor surface, which is divided into at least two segments, wherein a first segment of the sensor surface is dedicated to a driver of the vehicle, and a second segment of the sensor surface is dedicated to a passenger of the vehicle, and the driver is identified as the operator when it is determined that a finger is touching the first segment of the sensor surface, and the passenger is identified as the operator when it is determined that a finger is touching the second segment of the sensor surface.

10. The method according to claim 9, characterized in that the driver is identified as the operator when it has been determined that a finger is touching the first segment and a third segment of the sensor surface, and that the passenger is identified as the operator when it has been determined that a finger is touching the second segment and a third segment, wherein the third segment is located between the first segment and the second segment.

11. A motor vehicle that has an operating device for an infotainment system according to claim 1 for executing a method according to claim 8.

12. The operating device according to claim 2, characterized in that the sensor device has a sensor surface that is located at least in segments along the circumference of the operating element.

13. The operating device according to claim 2, characterized in that the sensor surface of the sensor device of the operating element is divided into at least two segments.

14. The operating device according to claim 3, characterized in that the sensor surface of the sensor device of the operating element is divided into at least two segments.

15. The operating device according to claim 2, characterized in that there is a comparison device for comparing fingerprints and a memory for storing fingerprints, wherein the sensor device is configured to identify the fingerprint of the operator, and the comparison device is configured to compare the identified fingerprint of the operator with a fingerprint of an authorized individual stored in the memory.

16. The operating device according to claim 3, characterized in that there is a comparison device for comparing fingerprints and a memory for storing fingerprints, wherein the sensor device is configured to identify the fingerprint of the operator, and the comparison device is configured to compare the identified fingerprint of the operator with a fingerprint of an authorized individual stored in the memory.

17. The operating device according to claim 4, characterized in that there is a comparison device for comparing fingerprints and a memory for storing fingerprints, wherein the sensor device is configured to identify the fingerprint of the operator, and the comparison device is configured to compare the identified fingerprint of the operator with a fingerprint of an authorized individual stored in the memory.

18. The operating device according to claim 5, characterized in that there is a comparison device for comparing fingerprints and a memory for storing fingerprints, wherein the sensor device is configured to identify the fingerprint of the operator, and the comparison device is configured to compare the identified fingerprint of the operator with a fingerprint of an authorized individual stored in the memory.

19. The operating device according to claim 6, characterized in that there is a comparison device for comparing fingerprints and a memory for storing fingerprints, wherein the sensor device is configured to identify the fingerprint of the operator, and the comparison device is configured to compare the identified fingerprint of the operator with a fingerprint of an authorized individual stored in the memory.

20. A motor vehicle that has an operating device for an infotainment system according to claim 2 for executing a method according to claim 8.
